(19) United States
(12) Patent Application Publication
(10) Pub. No.: US 2013/0037003 A1
(43) Pub. Date: Feb. 14, 2013

(54) METHOD AND SYSTEM FOR CONTROLLING COMBUSTION IN A DIESEL ENGINE

(71) Applicant: Geoffrey T. Sheerin, Sarnia (CA)

(72) Inventor: Geoffrey T. Sheerin, Sarnia (CA)

(73) Assignee: SHEER TECHNOLOGY INC., Sarnia (CA)

(21) Appl. No.: 13/641,005

(22) PCT Filed: Apr. 13, 2011
(86) PCT No.: PCT/CA2011/000421

§ 371 Date: Oct. 12, 2012

Related U.S. Application Data
(60) Provisional application No. 61/323,848, filed on Apr. 13, 2010.

(51) Int. Cl. F02M 69/04

(52) U.S. Cl. 123/445

(57) ABSTRACT

A system for controlling combustion in a diesel engine having one or more combustion chambers in which fuel is injected and air is compressed for combustion of the fuel. The system includes a hydrogen injector for injecting a first predetermined volume of hydrogen into the combustion chamber prior to combustion of the fuel, and an oxygen injector for injecting a second predetermined volume of oxygen into the combustion chamber prior to combustion of the fuel.

### TECHNICAL FIELD

The present invention is a method and a system for controlling combustion in a diesel engine.

### BACKGROUND OF THE INVENTION

As is well known in the art, the exhaust from a diesel internal combustion engine includes many toxic air contaminants. The air contaminants include nitrous oxides (NOx), which form when nitrogen and oxygen are mixed together (e.g., in air), and the mixture is subjected to high temperatures. At high temperatures, N₂ and O₂ in air disassociate into their atomic states, and a series of reactions result in nitrous oxides.

It is also well known that, in a diesel engine, O₂ is present in the combustion chamber immediately before combustion in amounts exceeding the stoichiometric amounts required for combustion, because of the quantity of oxygen in air. Accordingly, because excess oxygen is needed to form NOx, it is generally accepted that there is an undesirable excess of oxygen in the pre-combustion mixture. It follows that, in the prior art, the performance of the diesel engine typically is controlled primarily by controlling the fuel supply, rather than controlling the supply of air to the engine.

In the prior art, there have been various attempts to improve combustion efficiency, and also to decrease NOx production. For instance, exhaust gas recirculation (EGR) has been used, in an attempt to reduce NOx emissions. The idea is that EGR causes a combustion chamber's temperature to be significantly lower, and this in turn results in a decreased volume of NOx, because higher temperatures are needed for NOx formation. This is thought to be likely to lead to at least a partial reduction in the NOx produced. However, EGR has not provided the benefits expected as the EGR system has been mechanically unreliable, so much so that truck fleet owners often prefer to use older “rebuilt as new” engines that do not have EGR.

Hydrogen (H₂) has been added to the pre-combustion mixture, in another attempt to improve combustion efficiency. The idea is that the hydrogen combines with some of the excess oxygen, to produce steam and thereby cool the burn at the flame front. However, although hydrogen injection has achieved improvements in fuel consumption, it generally has not achieved the emissions performance of EGR on newer engines.

### SUMMARY OF THE INVENTION

There is therefore a need for a method and system of controlling combustion that addresses or mitigates one or more of the disadvantages of the prior art.

In its broad aspect, the invention provides a system for controlling combustion in a diesel engine having one or more combustion chambers in which fuel is injected and air is compressed for combustion of the fuel. The system includes a hydrogen injector for injecting a first predetermined volume of hydrogen into the combustion chambers prior to combustion of the fuel, and an oxygen injector for injecting a second predetermined volume of oxygen into the combustion chambers prior to combustion of the fuel. The second predetermined volume and the first predetermined volume define a non-elemental ratio of the second predetermined volume to the first predetermined volume.

In another aspect, the non-elemental ratio is between approximately 3:1 and approximately 3:1.5.

In another of its aspects, the invention additionally includes a source of electrical power, and one or more electrolytic assemblies electrically connectable to the source of electrical power, for generating the first and second predetermined volumes of hydrogen and oxygen respectively.

In yet another aspect, the invention provides a method of controlling combustion in a diesel engine including one or more combustion chambers in which fuel injected into a compressed volume of air combusts. The method includes providing a first volume of substantially pure oxygen gas, and providing a second volume of substantially pure hydrogen gas. Also prior to combustion, the first volume and the second volume are injected into the combustion chamber(s) in a non-elemental ratio.

The invention also provides a method of controlling combustion in a diesel engine including at least one combustion chamber in which fuel injected into a compressed volume of air combusts, the method comprising, providing a first volume of substantially pure oxygen gas, providing a second volume of substantially pure hydrogen gas, and prior to combustion, injecting the first volume and the second volume into said at least one combustion chamber in an elemental ratio.

In another aspect, the invention provides a system for controlling combustion in a diesel engine having at least one combustion chamber in which fuel is injected and air is compressed for combustion of the fuel, the system comprising: a hydrogen injector for injecting a first predetermined volume of hydrogen into said at least one combustion chamber prior to combustion of the fuel; and an oxygen injector for injecting a second predetermined volume of oxygen into said at least one combustion chamber prior to combustion of the fuel.

In yet another aspect, the second predetermined volume and the first predetermined volume define an elemental ratio of the second predetermined volume to the first predetermined volume.

### BRIEF DESCRIPTION OF THE DRAWINGS

The invention will be better understood with reference to the attached drawings, in which:

FIG. 1 is a schematic diagram of an embodiment of the system of the invention;

FIG. 2A is a front view of an embodiment of an electrolytic assembly of the invention and certain elements of an embodiment of a fluid control assembly of the invention;

FIG. 2B is a cross-section of the electrolytic assembly (and elements of the fluid control assembly) of FIG. 2A, taken along line A-A in FIG. 2A;

FIG. 2C is a cross-section of the electrolytic assembly (and elements of the fluid control assembly) of FIG. 2A, taken along line B-B in FIG. 2A;

FIG. 3A is a front view of the electrolytic assembly of FIG. 2A, drawn at a smaller scale;

FIG. 3B is a top view of the electrolytic assembly of FIG. 3A;

FIG. 3C is a bottom view of the electrolytic assembly of FIG. 3A;

FIG. 3D is a first side view of the electrolytic assembly of FIG. 3A;

FIG. 3E is an isometric view of the electrolytic assembly of FIG. 3A, drawn at a larger scale;

FIG. 3F is an isometric view of the electrolytic assembly (with elements of the fluid control assembly) of FIG. 2A with a bilge element positioned thereon, drawn at a smaller scale;

FIG. 4 is an exploded view of an embodiment of the fluid control assembly of the invention, drawn at a larger scale;

FIG. 5A is a cross-section of an embodiment of an electrolysis cell of the invention, drawn at a larger scale;

FIG. 5B is a plan view of an embodiment of an electrode of the invention, drawn at a smaller scale;

FIG. 5C is a plan view of an embodiment of another electrode of the invention;

FIG. 6A is a plan view of an embodiment of a spacer subassembly of the invention, drawn at a larger scale;

FIG. 6B is a cross-section of the spacer subassembly of FIG. 6A taken along line C-C in FIG. 6A;

FIG. 6C is a cross-section of the spacer subassembly of FIG. 6A taken along line D-D in FIG. 6A;

FIG. 6D is a cross-section of the spacer subassembly of FIG. 6A taken along line E-E in FIG. 6A, drawn at a larger scale;

FIG. 7 is a plan view of a grill element of the invention, drawn at a smaller scale;

FIG. 8 is a plan view of an embodiment of a gasket of the invention;

FIG. 9A is a plan view of an embodiment of a diaphragm element of the invention;

FIG. 9B is a cross-section of a portion of the electrolytic assembly of FIG. 3A showing two spacer subassemblies fitting together with an electrode and gaskets positioned between them, drawn at a smaller scale;

FIG. 10A is a side view of an embodiment of a backflow preventer of the invention, drawn at a larger scale;

FIG. 10B is a cross-section of the backflow preventer of FIG. 10A in which a float valve therein is in a first closed position;

FIG. 10C is a cross-section of the backflow preventer of FIG. 10A in which the float valve is in a floating position;

FIG. 10D is a cross-section of the backflow preventer of FIG. 10A in which the float valve is in a second closed position;

FIG. 11 is a side view of an embodiment of a water container of the invention and a tube connected thereto, drawn at a smaller scale;

FIG. 12 is a schematic diagram of an embodiment of a control assembly of the invention;

FIG. 13 is a schematic illustration of an embodiment of a method of the invention; and

FIG. 14 is a schematic illustration of another embodiment of a method of the invention.

### DETAILED DESCRIPTION

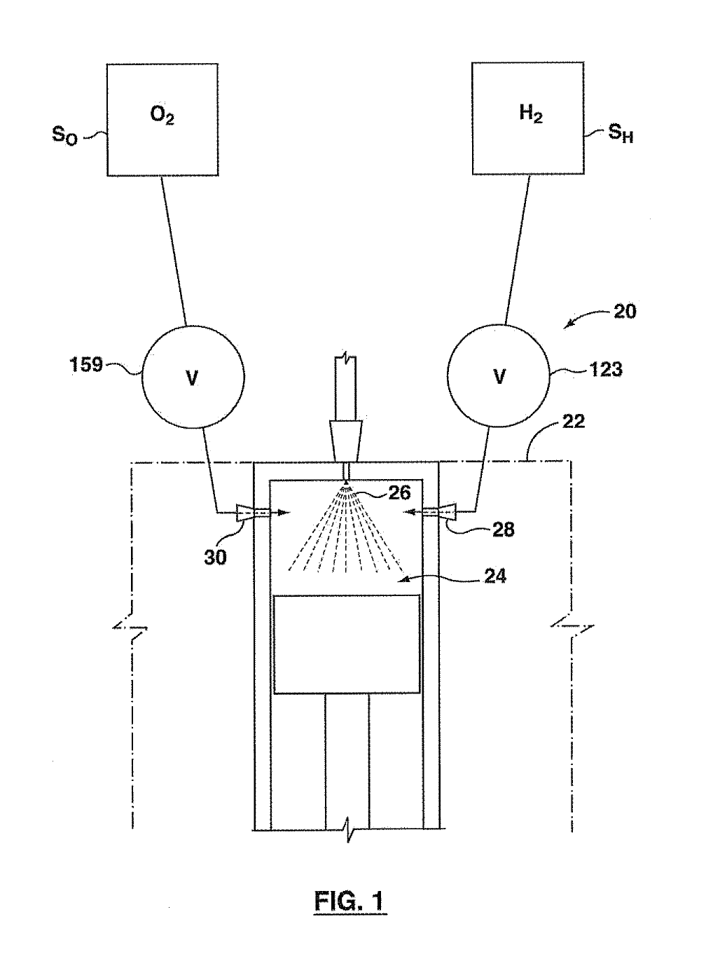

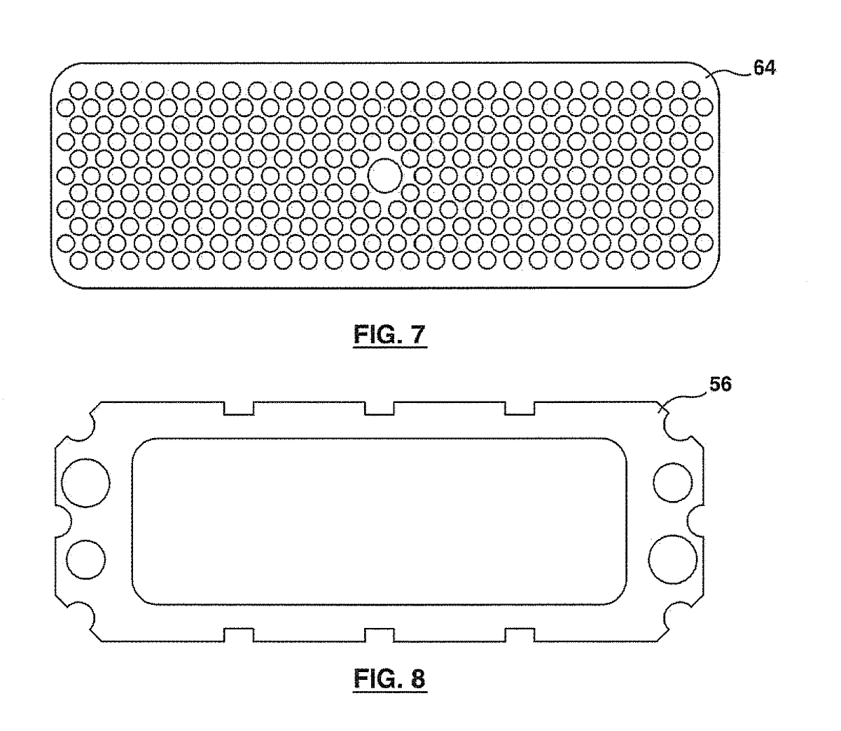

In the attached drawings, like reference numerals designated corresponding elements throughout. Reference is first made to FIGS. 1-12 to describe an embodiment of a system of the invention referred to generally by the numeral 20. As illustrated in FIG. 1, the system 20 is for controlling combustion in a diesel engine 22 having one or more combustion chambers 24 in which fuel 26 is injected and air is compressed for combustion of the fuel 26. In one embodiment, the system 20 includes a hydrogen injector 28 for injecting a first predetermined volume of hydrogen into the combustion chamber 24 prior to combustion of the fuel, and an oxygen injector 30 for injecting a second predetermined volume of oxygen into the combustion chamber 24 prior to combustion of the fuel. As will be described, it is preferred that the second predetermined volume and the first predetermined volume define a non-elemental ratio of the second predetermined volume to the first predetermined volume.

In another embodiment, the non-elemental ratio at which oxygen and hydrogen is provided to the combustion chamber is between approximately 3:1 and approximately 3:1.5.

Table I is set out below. As can be seen in Table I, the injection of additional oxygen appears to result in improved mileage and reduced NOx.

TABLE I

| | | | | Mass | |
|---|---|---|---|---|---|
| | | | | (NOₓ) | |
| | | NOₓ | Ratios | gm-bhp- | Speed |
| | MPG | ppm | (by Volume) | hr | MPH |
| Lifetime | 8.0300 | | | | |
| 233,000 | | | | | |
| miles | | | | | |
| Baseline | 7.91 | 1417.59 | | 4.92 | |
| Testing | | | | | |
| Best Results | 9.02 | 1008.74 | (1) “H”, (3) “O” | 3.33 | 60.00 |
| | | 28.84% Reduction | | | |
| Least | 7.83 | 1214.62 | (1.5) “H”, (3) | 3.54 | 60.00 |
| Results | | | “O” | | |

14.32% Reduction

A number of tests were conducted, with different types of diesel engines. Representative data from the tests is summarized in Table I. The data in Table I shows the results of testing a Detroit Diesel series 60 engine, pre-EGR. As can be seen in Table I, the best results are obtained when oxygen gas (O₂, referred to as “O” in Table I) and hydrogen gas (H₂, referred to as “H” in Table I) are injected into the combustion chamber(s) at a ratio by volume of approximately 3:1. When this ratio is used, there is a significant reduction in NOx emissions (28.84% reduction), as well as a significant improvement in mileage, i.e., an increase to 9.02 mpg, compared to a baseline mileage of 7.91 mpg. This improvement in mileage, with the decrease in NOx emissions, is surprising in view of the prior art.

As is known in the art, it is advantageous to generate hydrogen via electrolysis, i.e., using a portable electrolytic cell, where the diesel engine is mounted in a vehicle. This is because of the practical difficulties involved in transporting sufficient volumes of O₂ and H₂ in pressurized containers. The ratio of the volume of oxygen (O₂) to hydrogen (H₂) generated by electrolysis is approximately 1:2. Such ratio is defined, for the purposes hereof, as the “elemental ratio”. However, as can be seen in Table I, a non-elemental ratio, defined herein as a ratio other than the elemental ratio, has, surprisingly, been found to be advantageous. In particular, it is surprising that adding oxygen to the combustion chamber would improve combustion efficiency, because it is generally thought (as described above) that there is an excess of oxygen in diesel combustion chambers.

Accordingly, the results in Table I are counter-intuitive, i.e., it is surprising that an increase in the oxygen present in the pre-combustion mixture in the combustion chamber would result in improved fuel combustion efficiency. It is not clear why this is so. One possible explanation is that, because of the excess oxygen introduced into the combustion chamber using the invention herein, more fuel droplets combust than otherwise would.

The “least results” are obtained when the ratio of O₂ to H₂ is approximately 3:1.5, i.e., the ratio is approximately the elemental ratio. Accordingly, as shown in Table I, injecting O₂ and H₂ into the combustion chamber(s) 24 in substantially the elemental ratio also achieves significant improvements in performance, i.e., improvements in mileage, and improvements (reductions) in NOx emissions.

In summary, the test results surprisingly indicate:
(a) that adding O₂ to the combustion chamber(s) 24 with H₂ in the elemental ratio results in significant improvements in performance; and
(b) that adding O₂ to the combustion chamber(2) 24 in a non-elemental ratio (in which the ratio of O₂ to H₂ exceeds the elemental ratio) results in even more significant improvements in performance. This has been found to be so up to a non-elemental ratio of O₂ to H₂ of approximately 3:1.

In another embodiment of the system of the invention, the system includes the hydrogen injector for injecting a first predetermined volume of hydrogen into the combustion chamber(s) prior to combustion of the fuel, and the oxygen injector for injecting a second predetermined volume of oxygen into the combustion chamber(s) prior to combustion of the fuel. From the foregoing description, it will be appreciated by those skilled in the art that the ratio of the second predetermined volume to the first predetermined volume may advantageously be an elemental ratio.

In FIG. 1, the sources of the hydrogen and the oxygen are referred to as S_{H} and S_{O} respectively. In one embodiment, the flow of hydrogen and oxygen from the sources S_{H}, S_{O} preferably is controlled by valves 123, 159 respectively, as will be described.

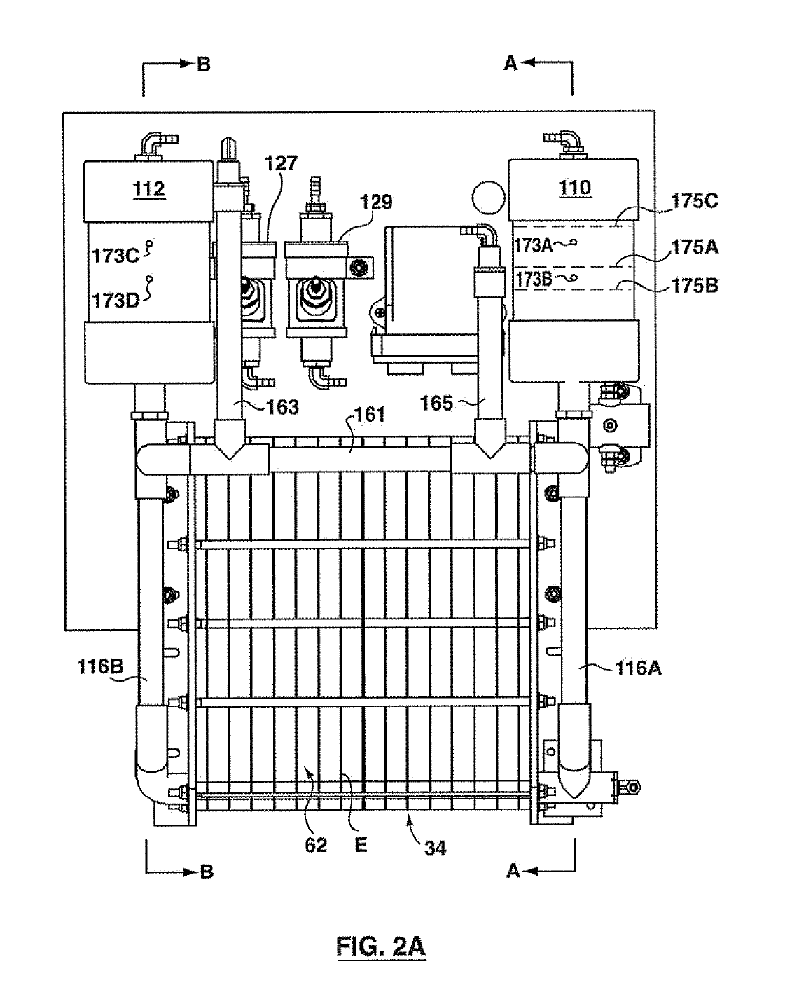

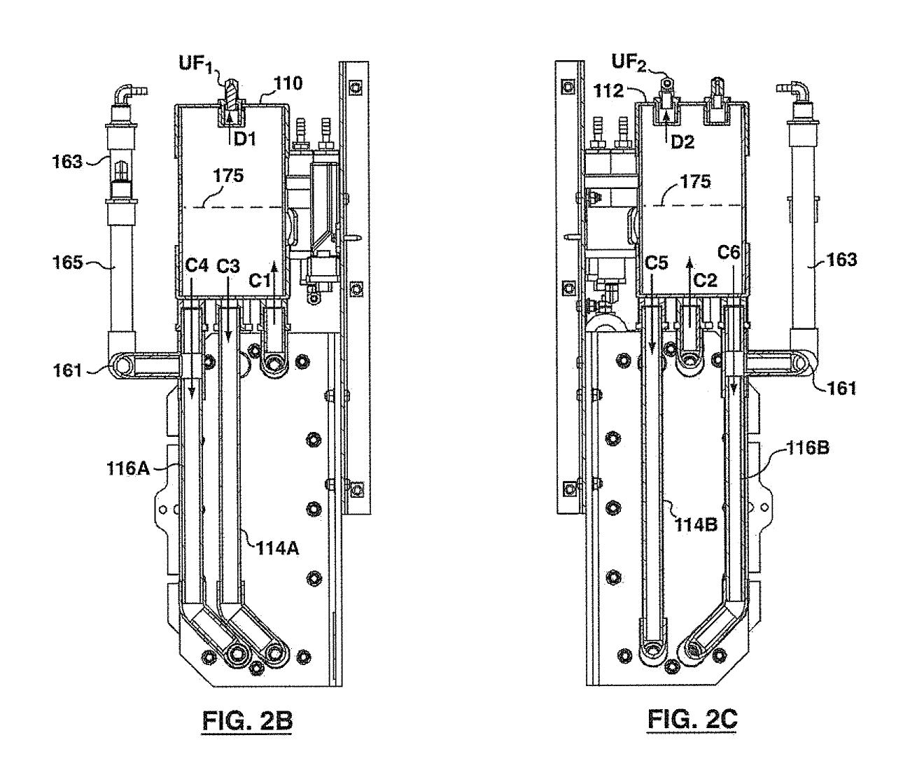

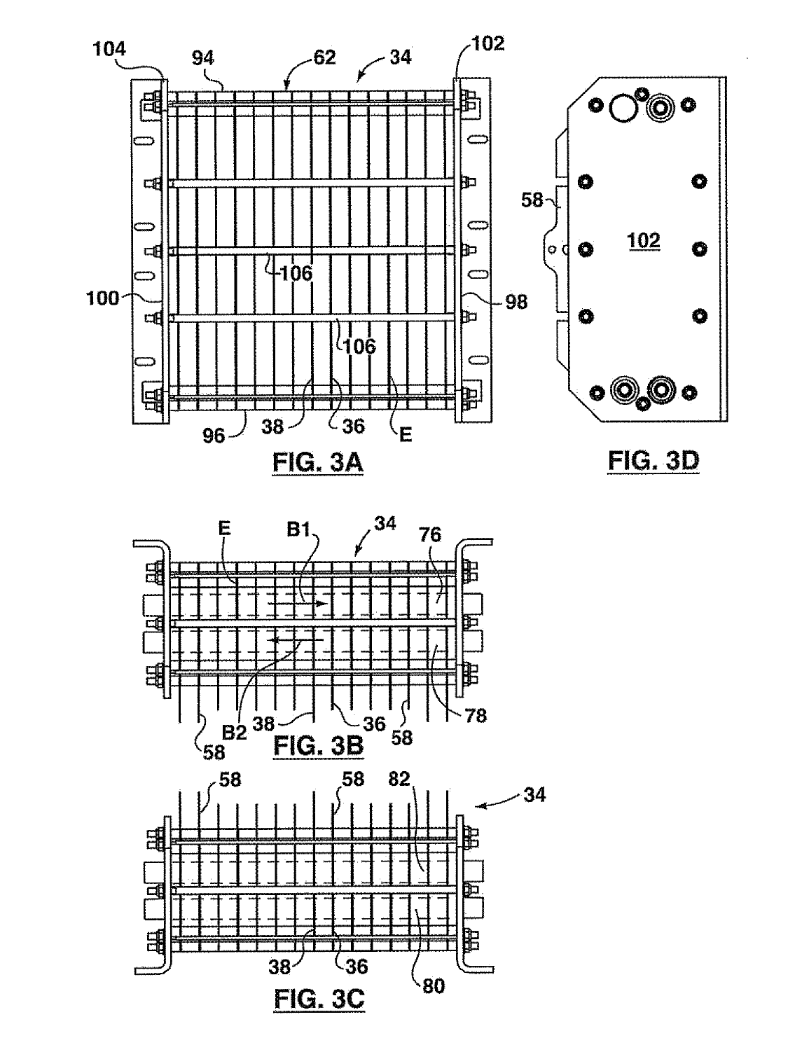

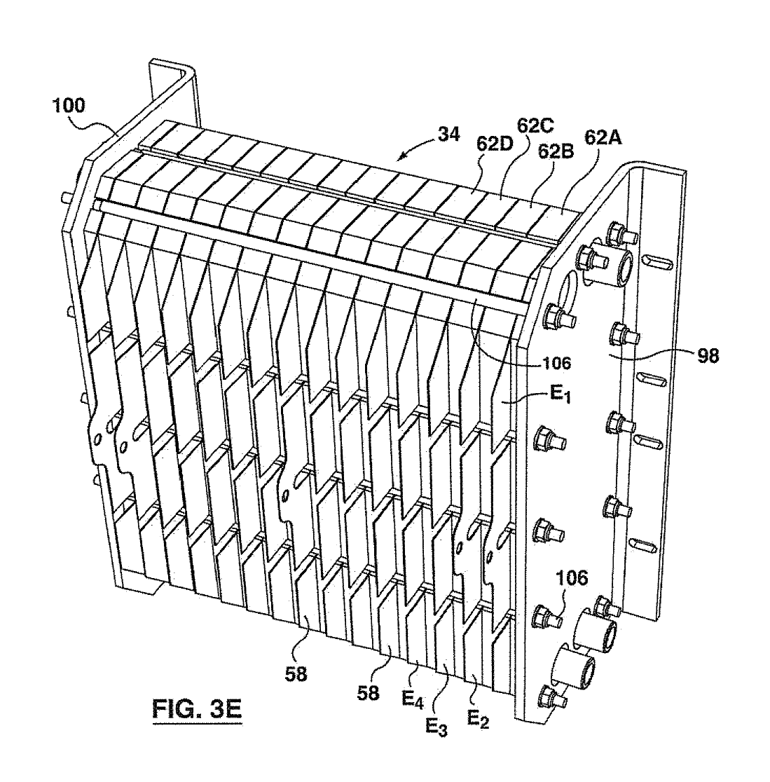

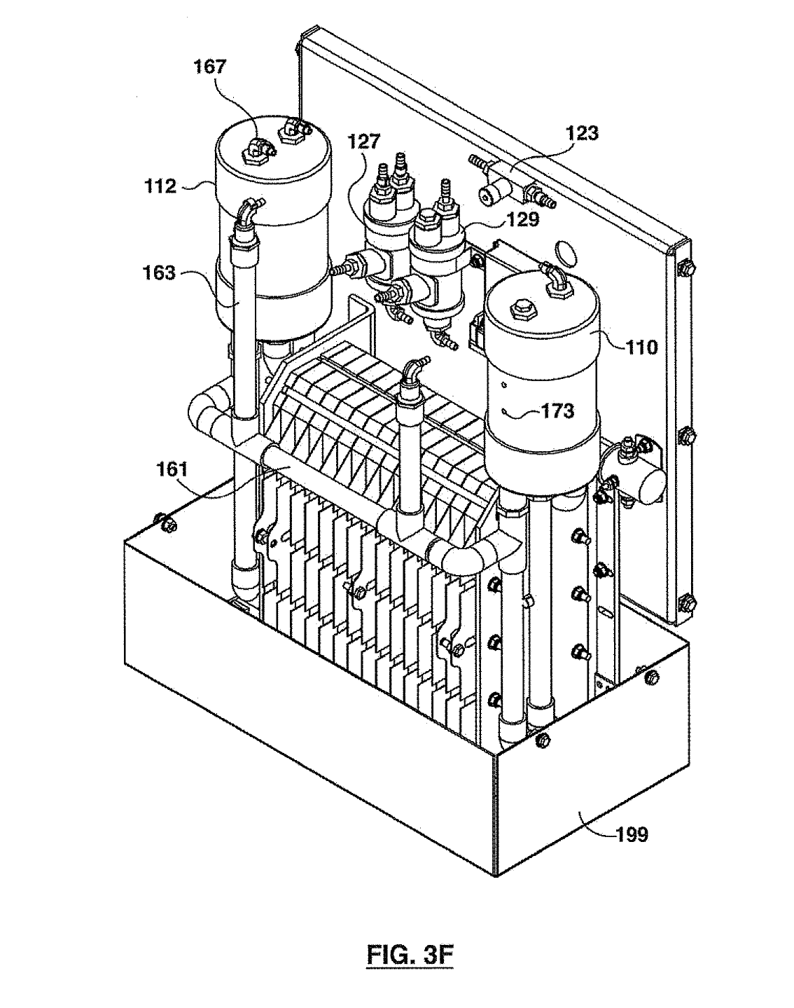

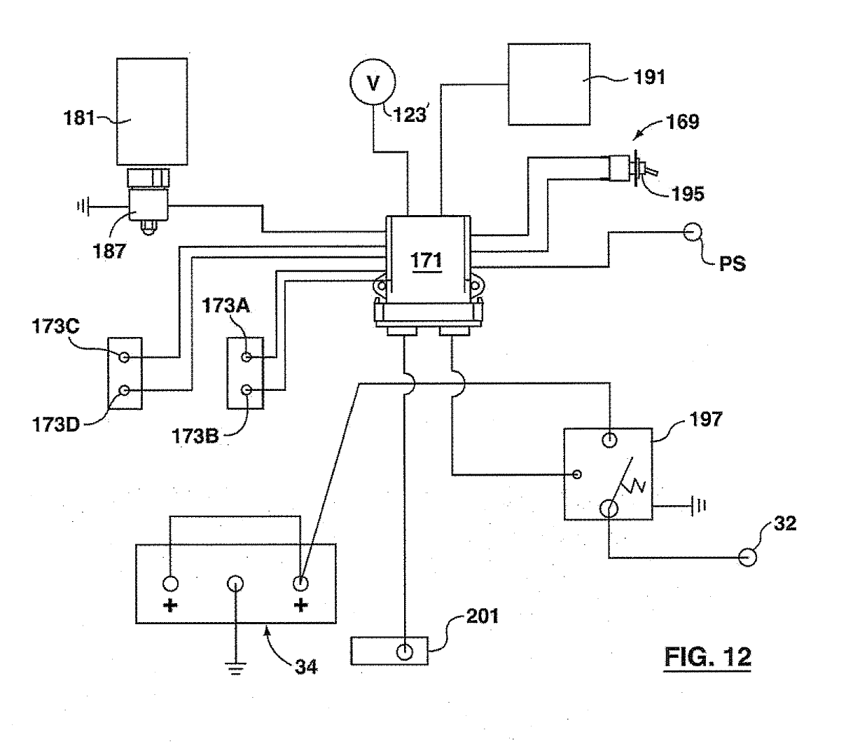

It will be appreciated by those skilled in the art that the hydrogen and the oxygen may be provided in the system by any suitable sources. In particular, if the system is immobile or in a large ship, the sources of hydrogen and the oxygen may be pressurized tanks of those gases. However, as is known in the art, in roadworthy vehicles (e.g., trucks or cars), pressurized tanks are generally not authorized for use. Accordingly, in one embodiment, it is preferred that the system 20 additionally includes a source 32 of electrical power (FIG. 12), and one or more electrolytic assemblies 34 (FIGS. 2A, 3A-3E) electrically connectable to the source of electrical power, for generating the first and second predetermined volumes of hydrogen and oxygen respectively. As will be described, it is also preferred that, if the system is mounted in a vehicle, the source 32 of electrical power is in the vehicle's electrical system.

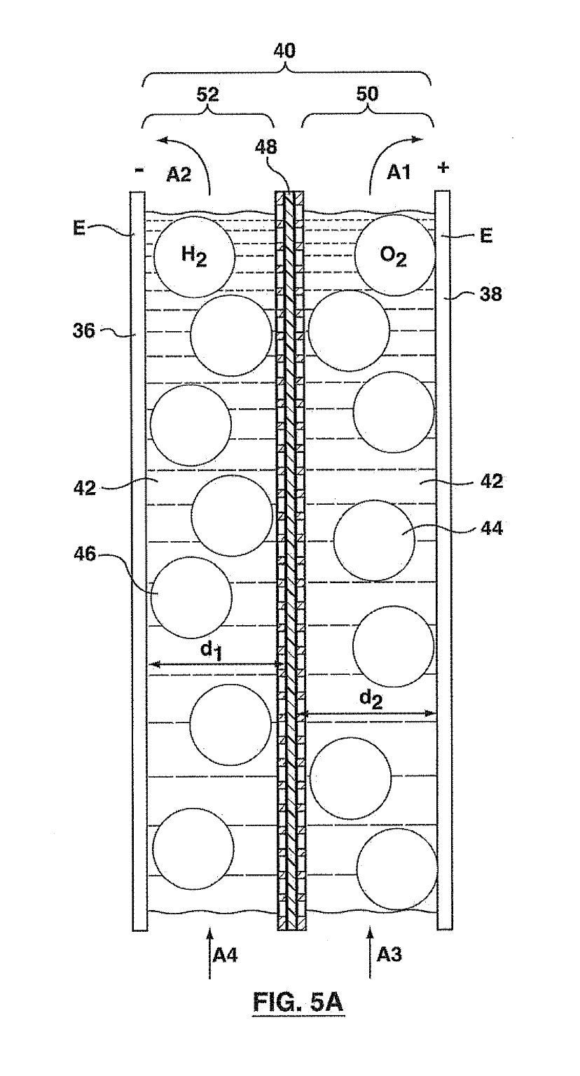

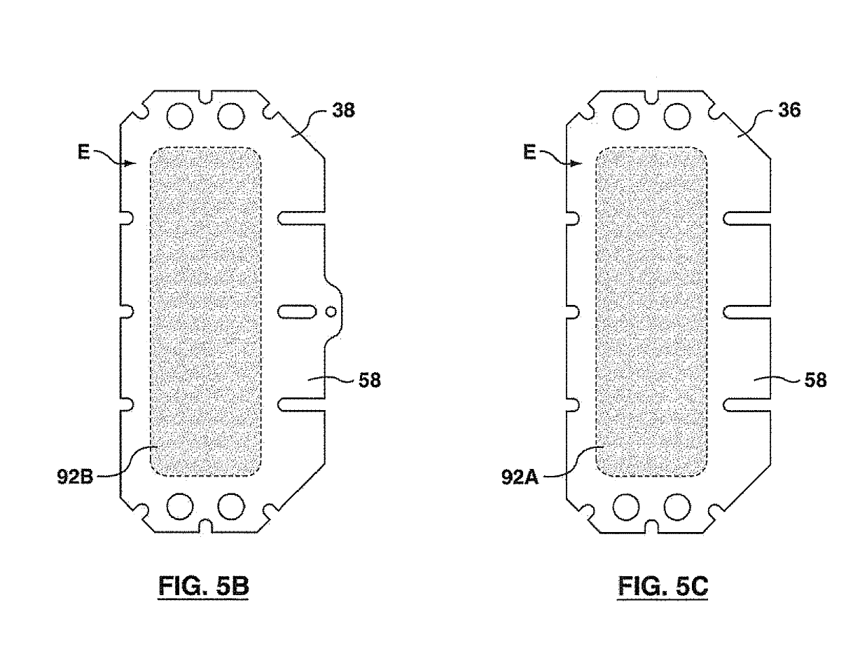

Preferably, the electrolytic assembly 34 includes one or more cathodes 36 and one or more anodes 38 (FIGS. 3A-3C, 3E, 5A, and 6D). As can be seen in FIG. 5A, the cathode 36 and the anode 38 at least partially define an electrolytic cell 40 therebetween. It is preferred that an electrolyte solution 42 is positionable in the electrolytic cell 40, where the electrolyte solution 42 is subjected to electrolysis when the source of electrical power is electrically connected to the anode 38, causing the water to at least partially decompose into oxygen 44 and hydrogen 46.

As is known in the art, an electrode “E” may function as a cathode or an anode, depending on the circumstances. For the purposes hereof, the invention is described as including cathodes and anodes, it being understood that the function of a particular electrode may change, depending on the circumstances.

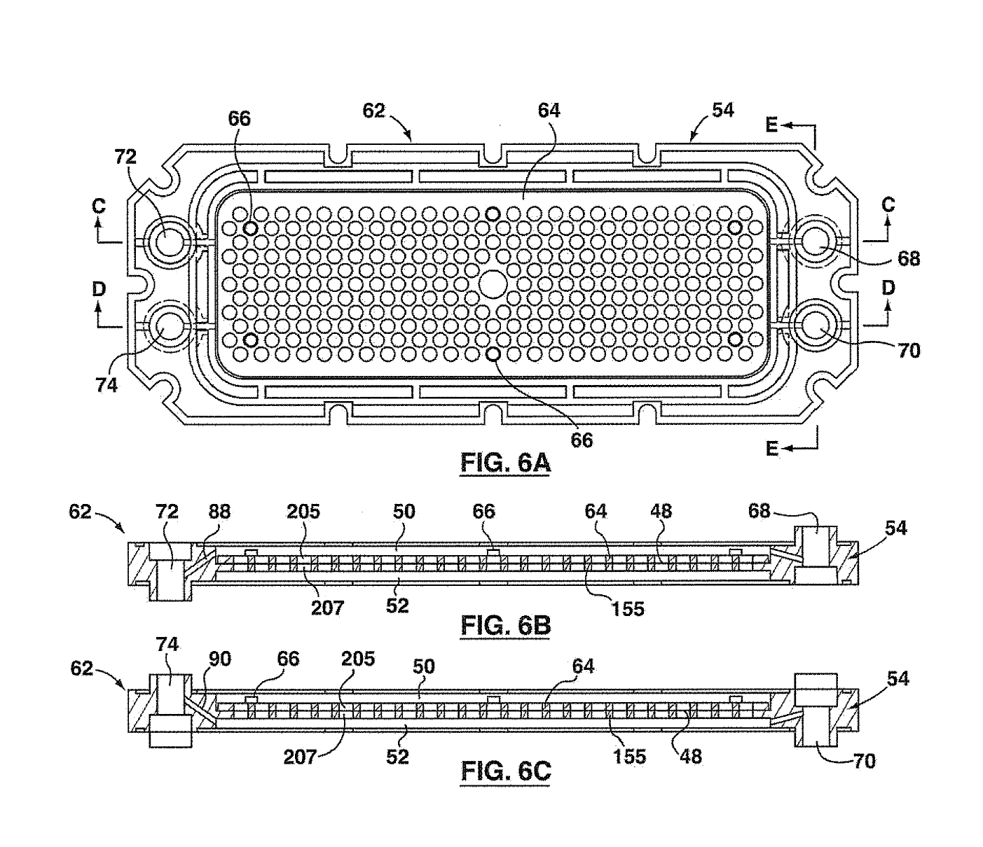

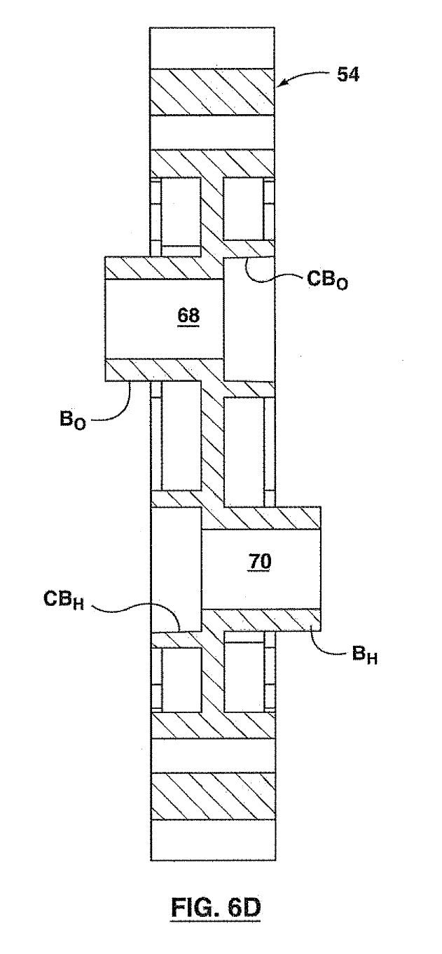

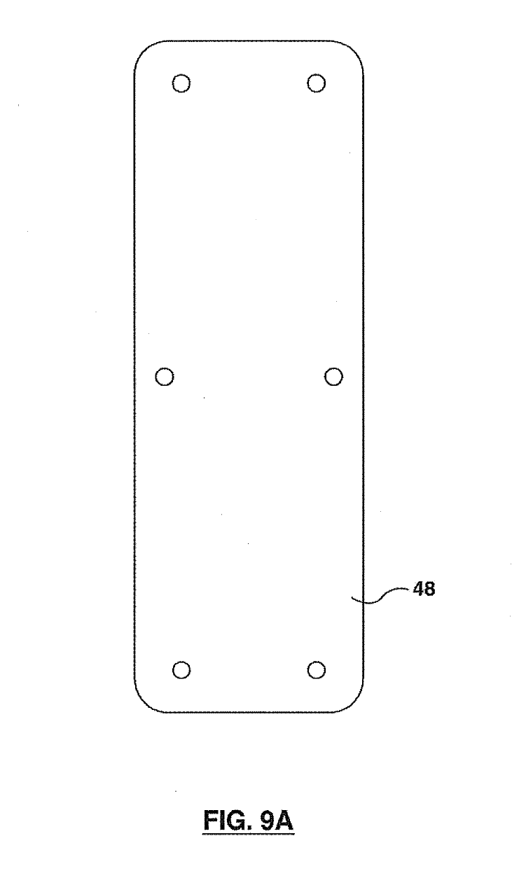

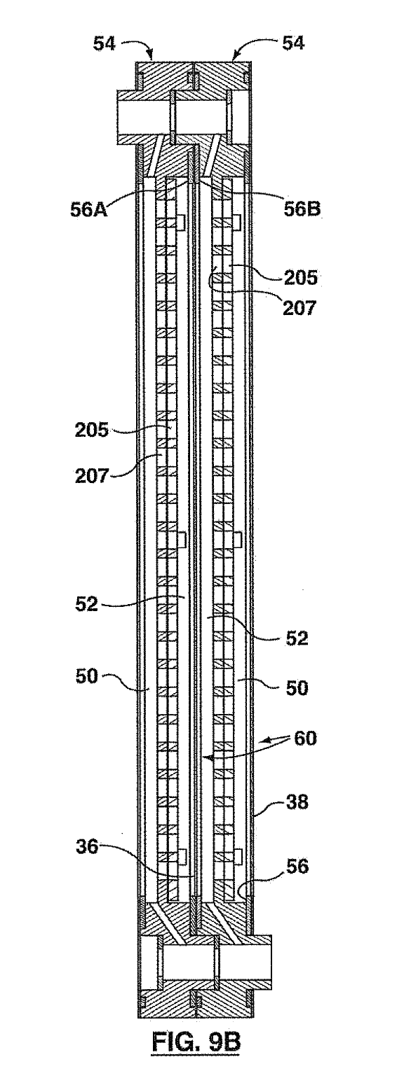

As illustrated in FIG. 5A, the electrolytic assembly 34 preferably includes a diaphragm element 48 positioned between the cathode 36 and the anode 38, to divide the electrolytic cell 40 into an oxygen compartment 50 and a hydrogen compartment 52. It will be understood that the thickness of the diaphragm element 48 is exaggerated (i.e., not drawn to scale) in FIG. 5A, for clarity of illustration. Also, the elements supporting the diaphragm element 48 in FIG. 5A are simplified for clarity of illustration, as will be described. The structure of the relevant elements can be seen in FIGS. 6A-6D and 9B, as will be described.

As can be seen in FIG. 5A, during electrolysis, hydrogen gas 46 appears at the cathode (the negatively charged electrode), and oxygen gas 44 appears at the anode (the positively charged electrode), due to the decomposition of some of the water in the electrolyte solution 42. As is well known in the art, the hydrogen gas 46 appears at the cathode due to reduction of hydrogen cations. At the anode, an oxidation reaction takes place, generating oxygen gas 48 and providing electrons to the anode. Also, hydrogen cations results from the oxidation reaction, and the hydrogen cations thus generated may pass through the diaphragm element 48 to the cathode, to form hydrogen gas 46.

It is also well known in the art that, because the electrolysis of pure water requires excess energy, an electrolyte preferably is added to the water, to provide the electrolyte solution, which is suitably conductive. Various suitable electrolytes are known, and various suitable electrolyte solutions are known. In the invention herein, it has been found that KOH (potassium hydroxide) is a suitable electrolyte, and a solution of approximately 45% KOH and 55% water is a suitable electrolyte solution. (These proportions are hereinafter referred to as the “predetermined proportions”.) However, it will be understood that any suitable electrolyte, and any suitable electrolyte solution, may be used.

Preferably, the diaphragm element 48 is any suitable electrolytic cell barrier. In one embodiment, the diaphragm element 48 preferably is a sheet of nylon cloth approximately 1 mm (approximately 0.04 inch) thick. The nylon sheet is preferable because it is relatively inexpensive, and has been found to be relatively durable. The diaphragm element 48 is intended to keep the hydrogen and the oxygen generally separate, while allowing current to pass between the cathode and the anode. Any suitable nylon woven fabric (nylon cloth) may be used as the diaphragm member.

However, it has been found that the nylon sheet 48 permits some mixture of oxygen and hydrogen gases in the electrolytic cell, to a very limited extent. The amounts of hydrogen mixed with oxygen have not been significant in view of the ratios at which the gases are provided to the combustion chamber. In view of the cost of an improved barrier which would keep the oxygen and hydrogen virtually separated, and the minimal benefit that the improved barrier would provide, it is thought that the nylon diaphragm element provides the optimum performance. It will be understood that references herein to hydrogen 46 and oxygen 44 are not necessarily references to pure hydrogen or oxygen, because of the possibility that small proportions of the hydrogen 46 and oxygen 44 produced from the hydrogen compartment 52 and the oxygen compartment 50 may be oxygen and hydrogen respectively.

As illustrated in FIG. 5A, the bubbles of hydrogen 46 and oxygen 44 which appear in the hydrogen compartment 52 and the oxygen compartment 50 move upwardly. The distances d₁ and d₂ respectively between the cathode 36 and the diaphragm element 48, and between the anode 38 and the diaphragm element 48, preferably are the same, i.e., the diaphragm element 48 preferably is substantially equidistant from the cathode and the anode. The distances d₁ and d₂ have been selected for optimum performance of the electrolytic cell. It has been found that, if the distances are too small, then the bubbles of gases (hydrogen and oxygen) tend to clog the hydrogen and oxygen compartments respectively. However, if the distances are too large, the bubbles of gases tend to be unable to cause consistent and substantially constant movement of the electrolyte solution upwardly, and out of the hydrogen and oxygen compartments. It has been found that the optimum d₁ and d₂ is approximately 9 mm (approximately 0.35 inches).

As indicated above, the diaphragm element 48 is relatively thin, i.e., approximately 1 mm (approximately 0.04 inch) thick. Accordingly, it is preferred that the cathode 36 and the anode 38 are spaced apart by a distance (d₁ plus d₂, plus the thickness of the diaphragm element 48) of approximately 19 mm (approximately 0.75 inches).

It will be understood that, while the electrolyte is subjected to electrolysis, oxygen 44 and electrolyte solution 42 exit the oxygen compartment 50 at the top end thereof, as indicated by arrow A1 in FIG. 5A. Similarly, hydrogen 46 and electrolyte solution 42 exit the hydrogen compartment 52 at the top end thereof, as indicated by arrow A2 in FIG. 5A. At the same time, electrolyte solution 42 is added at the bottom ends of the oxygen and hydrogen compartments 50, 52 respectively, as indicated by arrows A3 and A4.

It will be appreciated by those skilled in the art that, because the water in the electrolyte solution decomposes into hydrogen and oxygen during electrolysis, the electrolyte solution exiting the hydrogen and oxygen compartments at the top ends thereof has a higher proportion of the electrolyte therein than the electrolyte solution entering the hydrogen and oxygen compartments. However, not all of the water is decomposed during one pass of the electrolyte solution through the electrolytic cell. As will be described, water in the electrolyte solution is replenished from time to time, as required.

Preferably, and as will be described, the electrolytic assembly 34 includes one or more spacer bodies 54, for locating the diaphragm element 48 (FIGS. 6A-6C). It is also preferred that the electrolytic assembly 34 additionally includes a number of gaskets 56. As shown in FIG. 9B, for a particular electrolytic cell 40, each gasket 56 preferably is positioned between the spacer body 54 and a selected one of the cathode 36 and the anode 38 respectively, to provide substantially watertight seals between the cathode 36 and the anode 38 respectively and the spacer body 54.

In one embodiment, the electrodes (i.e., both the cathode 36 and the anode 38) preferably each include a fin portion 58 thereof extending outwardly from the gasket 56 adjacent thereto, for dissipating heat generated by electrolysis in the electrolytic cell. As noted above, because each of the electrodes may function as a cathode or an anode at different times, it will be understood that the identification of the electrodes in FIGS. 5B and 5C as a cathode and an anode is for clarity of illustration only. As can be seen in FIGS. 3B and 3C, the fin portion 58 preferably is exposed to ambient air on both sides thereof for transfer of heat therefrom.

As shown in FIGS. 2A, 3A-3C and 3E-3F, the electrolytic assembly 34 preferably includes a number of cathodes 36 and a number of anodes 38, the cathodes and anodes being arranged in pairs 60, each pair 60 of a cathode and an anode at least partially defining the electrolytic cell 40 therebetween. It is also preferred that each electrolytic cell 40 is also at least partially being defined by a spacer subassembly 62. In one embodiment, each spacer subassembly 62 includes the spacer body 54, the diaphragm element 48, and a grill element 64. Preferably, the grill element 64 is positioned for holding the diaphragm element 48 against a central portion 155 of the spacer body 54. The grill element 64 and the central portion 155 preferably include openings therein 205, 207 respectively, so that the electrolyte solution 42 on both sides of the diaphragm element 48 is engaged with the diaphragm element, via the openings 205, 207. It is preferred that the openings 205, 207 are substantially aligned when the spacer subassembly 62 is in position in the electrolytic assembly 34.

In one embodiment, the grill element 64 preferably is secured to the spacer body 54, so that the diaphragm element 48 is held between the spacer body 54 and the grill element 64. Those skilled in the art would be aware of various means for securing the grill element 64 to the spacer body 54. Preferably, the grill element 64 is held in place by pins 66 pushed through selected holes in the grill element 64 which register with holes in the central portion 155 of the spacer body 54 when the grill element 64 is in position on the spacer body 54. The pins 66 preferably are further secured in position by glue (not shown) applied after the pins 66 are inserted.

As can be seen in FIG. 9B, preferably, the diaphragm element 48 for the electrolytic cell 40 is located by the spacer body 54 in a predetermined location approximately midway between the cathode 36 and the anode 38 for the electrolytic cell 40 to partially define the oxygen compartment 50, in which the electrolyte solution 42 is engaged with the anode 38 for the electrolytic cell 40, and in which oxygen appears when the electrolyte solution 42 is subjected to electrolysis, and the hydrogen compartment 52, in which the electrolyte solution 42 is engaged with the cathode 36 for the electrolytic cell 40, and in which hydrogen appears when the electrolyte solution 42 is subjected to electrolysis. It will be appreciated by those skilled in the art that FIG. 9B shows a portion of the electrolytic assembly 34, but in other portions of the electrolytic assembly 34, the arrangements of cathodes and anodes may be different, depending on how the electrodes are connected to the power source 32.

In one embodiment, and as can be seen in FIG. 9B, the electrolytic assembly 34 additionally includes a number of the gaskets 56. For each electrolytic cell 40, two of the gaskets 56 are mounted between the cathode 36 and the anode 38 therefor respectively, between which the spacer body 54 is positioned. For example, in FIG. 9B, the cathode 36 is shown positioned between two gaskets, identified for clarity in FIG. 9B as 56A and 56B.

In one embodiment, each spacer body 54 preferably includes an oxygen conduit portion 68, a hydrogen conduit portion 70, a first electrolyte solution conduit portion 72, and a second electrolyte solution conduit portion 74 (FIGS. 6B, 6C). It is also preferred that the spacer bodies 54 cooperate to define an oxygen conduit 76 including the oxygen conduit portions 68, for permitting oxygen 44 and the electrolyte solution 42 to flow from the oxygen compartments 50 (FIG. 3B). Also, the spacer bodies 54 cooperate to define a hydrogen conduit 78 including the hydrogen conduit portions 70, for permitting hydrogen 46 and the electrolyte solution 42 to flow from the hydrogen compartments 52 (FIG. 3B).

The direction in which the oxygen and the electrolyte solution exiting the oxygen compartments 50 flows through the oxygen conduit 76 is indicated by arrow B1 in FIG. 3B. Also it can be seen in FIG. 3B that the hydrogen, and the electrolyte solution exiting the hydrogen compartments 52, flows through the hydrogen conduit 78 in the direction indicated by arrow B2 in FIG. 3B.

Preferably, the spacer bodies 54 also cooperate to define a first electrolyte solution conduit 80 including the first electrolyte solution conduit portions 72, for permitting the electrolyte solution 42 to flow into the oxygen compartments 50 (FIG. 3C). In addition, the spacer bodies 54 preferably also cooperate to define a second electrolyte solution conduit 82 including the second electrolyte solution conduit portions 74, for permitting the electrolyte solution 42 to flow into the hydrogen compartments 52 (FIG. 3C).

As will be described, the electrolyte solution flows into the first electrolyte solution conduit 80 from both ends thereof. Also, the electrolyte solution flows into the second electrolyte solution conduit 82 from both ends thereof.

As can be seen in FIGS. 6B and 6C, each spacer body 54 additionally includes an oxygen output tube 84 in fluid communication with the oxygen compartment 50 and the oxygen conduit portion 68 thereof, for permitting the oxygen 44 and the electrolyte solution 42 to flow from the oxygen compartment 50 into the oxygen conduit 76. It is also preferred that the spacer body 54 includes a hydrogen output tube 86 in fluid communication with the hydrogen compartment 52 and the hydrogen conduit portion 70, for permitting the hydrogen 46 and the electrolyte solution 42 to flow from the hydrogen compartment 52 into the hydrogen conduit 78. Preferably, the spacer body 54 additionally includes a first electrolyte solution input tube 88 in fluid communication with the oxygen compartment 50 and the first electrolyte solution conduit portion 72, for permitting the electrolyte solution 42 to flow from the first electrolyte solution conduit 80 into the oxygen compartment 50. Also, the spacer body 54 preferably includes a second electrolyte solution input tube 90 in fluid communication with the hydrogen compartment 52 and the second electrolyte solution conduit portion 82, for permitting the electrolyte solution 42 to flow from the second electrolyte solution conduit 82 into the hydrogen compartment 52.

In one embodiment, each of the cathodes 36 and each of the anodes 38 includes an engagement region (FIGS. 5B, 5C). (For the purposes of clarity, the engagement portion on the cathode 36 is designated 92A, and the engagement portion on the anode 38 is designated 92B.) The engagement region 92A, 92B preferably is positioned for engagement with the electrolyte solution 42 in the electrolytic cell 40 at least partially defined by the cathode 36 and the anode 38. It is also preferred that the engagement region 92A, 92B is treated to substantially remove discontinuities thereon. This is done in order to make the engagement region 92A, 92B relatively smooth, i.e., to substantially eliminate any sharp edges from the engagement region 92A, 92B. This is done to minimize, to the extent feasible, the possibility of sharp edges or points in the engagement region 92A, 92B which, if they exist, tend to concentrate electrical current thereat.

Any suitable means for smoothing the engagement portion could be used. For instance, it is preferred that the electrodes are made of stainless steel. In this situation, the engagement portion 92A, 92B may be created by sandblasting those portions of the cathode and the anode.

As can be seen in FIGS. 3A-3F, the electrolytic assembly 34 preferably extends between top and bottom ends 94, 96, and between first and second sides 98, 100. Preferably, first and second end plates 102, 104 are positioned at the first and second sides respectively. As illustrated in FIG. 3E, to form the electrolytic assembly 34, the spacer subassemblies 62 are positioned adjacent to each other, with the electrodes E therebetween. In FIG. 3E, certain spacer subassemblies are designated 62A-62D to illustrate this, with certain electrodes designated E₁-E₄.

It is also preferred that connecting rods 106, threaded at each end thereof, are secured using nuts to the first and second end plates 102, 104, to maintain in position the spacer bodies, the electrodes 36, 38, and the other elements of the electrolytic assembly that are proximal to the electrolytic cells.

As can be seen in FIG. 6D, the oxygen conduit portion 68 and the hydrogen conduit portion 70 are each defined by boss segments B_{O}, B_{H} and counterbore segments CB_{O}, CB_{H} respectively. As illustrated in FIG. 6D, for example, the oxygen conduit portion 68 is defined by boss segment B_{O}, extending to the left, and to the right thereof, the counterbore segment CB_{O}. It will be understood that, when the spacer body 54 is in the assembled electrolytic assembly, a boss (not shown) from an element on the right is positioned in the counterbore CB_{O}, and the boss Bo will be inserted in a counterbore in an element on the left. In this way, the bosses and counterbores of adjacent elements cooperate to define the oxygen conduit 76.

In the same way, the bosses and counterbores that individually define a number of hydrogen conduit portions fit together (when the elements are positioned adjacent to each other) to cooperate to define the hydrogen conduit 78. Also, and as can be seen in FIGS. 6A-6C, it is preferred that each of the first and second electrolyte solution conduit portions is defined by a boss and an adjacent counterbore. As described above, the bosses and the counterbores in adjacent elements preferably cooperate to define the first and second electrolyte solution conduits 80, 82.

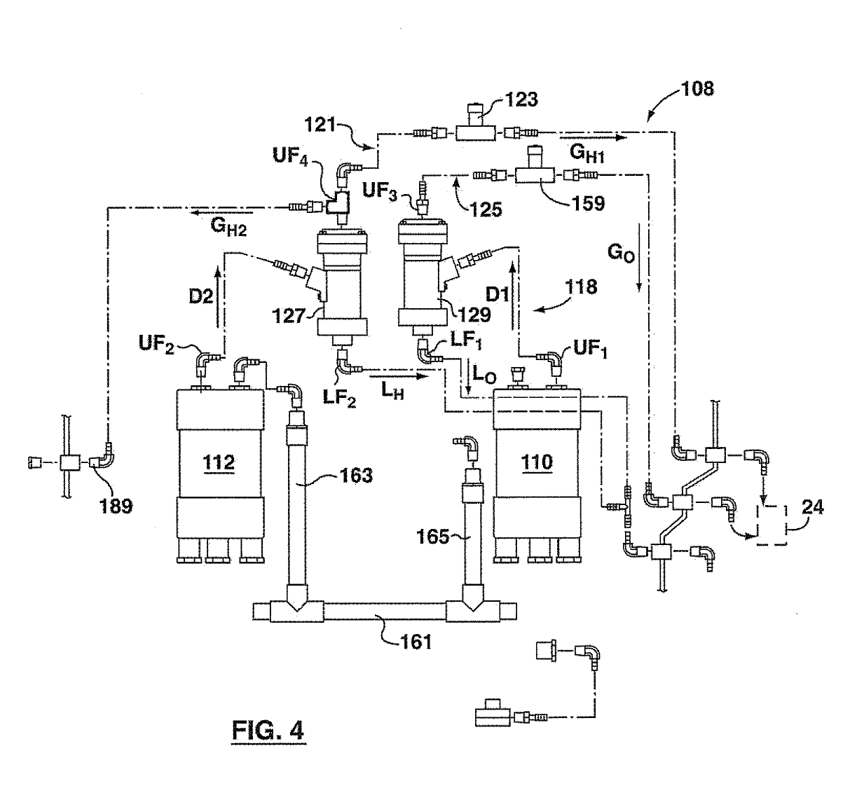

In one embodiment, the system 20 preferably also a fluid control assembly 108, for controlling flows of fluids to and from the electrolytic assembly 34 (FIGS. 2A, 4). In particular, the fluid control assembly 108 is for controlling the flow of gases (i.e., hydrogen 46 and oxygen 44) from the electrolytic assembly 34, and the flow of liquid (i.e., the electrolyte solution 42) to and from the electrolytic assembly 34.

In one embodiment, the fluid control assembly 108 preferably includes an oxygen separator chamber 110, in which the oxygen 44 and the electrolyte solution 42 provided from the oxygen compartments 50 via the oxygen conduit 76 are collected, and separated by gravity, and a hydrogen separator chamber 112, in which the hydrogen 46 and the electrolyte solution 42 provided from the hydrogen compartments 52 via the hydrogen conduit 78 are collected, and separated by gravity.

It is also preferred that the fluid control assembly 108 includes a pair of first electrolyte solution return pipes 114A, 114B (FIGS. 2B, 2C), one of each first electrolyte solution return pipes 114A, 114B extending from each of the oxygen separator chamber 110 and the hydrogen separator chamber 112 respectively to the first electrolyte solution conduit 80, for directing the electrolyte solution 42 from the oxygen separator chamber 110 and the hydrogen separator chamber 112 respectively to the first electrolyte solution conduit 80. Preferably, the fluid control assembly 108 also includes a pair of second electrolyte solution return pipes 116A, 116E (FIGS. 2B, 2C), one of each second electrolyte solution return pipes 116A, 1168 extending from each of the oxygen separator chamber 110 and the hydrogen separator chamber 112 respectively to the second electrolyte solution conduit 82, for directing the electrolyte solution 42 from the oxygen separator chamber 110 and the hydrogen separator chamber 112 respectively to the second electrolyte solution conduit 82.

For example, as schematically indicated by arrow C1 in FIG. 28, the oxygen and electrolyte solution exiting the oxygen compartments move upwardly into the oxygen separator chamber 110. Similarly, the movement of the hydrogen and electrolyte solution into the hydrogen separator chamber 112 is schematically indicated by arrow C2 in FIG. 2C.

The electrolyte solution in the oxygen separator chamber 110 preferably exits the oxygen separator chamber 110 via the first and second electrolyte solution return pipes 114A, 116A, as schematically indicated by arrows C3 and C4 (FIG. 2B). Also, the electrolyte solution in the hydrogen separator chamber 112 exits the hydrogen separator chamber 112 via the first and second electrolyte return pipes 114B, 116B, as schematically indicated by arrows C5 and C6 (FIG. 2C).

Preferably, the oxygen moves upwardly out of the electrolyte solution in the oxygen separator chamber 110 and exits the oxygen separator chamber 110 via an upper fitting UF₁, as schematically indicated by arrow D1 (FIG. 2B). Similarly, the hydrogen preferably moves upwardly out of the electrolyte solution in the hydrogen separator chamber 112 and exits the hydrogen separator chamber 112 via an upper fitting UF₂, as schematically indicated by arrow D2 (FIG. 2C).

In one embodiment, the fluid control assembly 108 additionally includes a gas direction segment 118 (FIG. 4) for directing the first predetermined volume of hydrogen 46 and the second predetermined volume of oxygen 44 from the hydrogen separator chamber 112 and the oxygen separator chamber 110 respectively to the combustion chamber(s) 24. Preferably, the gas direction segment 118 includes a hydrogen subsegment 121 for permitting the hydrogen 46 to flow from the hydrogen separator chamber 112 to the combustion chamber(s) 24. The hydrogen subsegment 121 preferably also includes one or more hydrogen control valves 123 for controlling the flow of the hydrogen 46 to the combustion chamber(s) 24. It is also preferred that the gas direction segment 118 includes an oxygen subsegment 125 for permitting the oxygen 44 to flow from the oxygen separator chamber 110 to the combustion chamber(s) 24.

Preferably, the hydrogen subsegment 121 includes a hydrogen subsegment backflow preventer 127, for preventing the electrolyte solution 42 flowing into the hydrogen subsegment 121 from flowing to the combustion chamber(s) 24. Also, the oxygen subsegment 125 preferably includes an oxygen subsegment backflow preventer 129, for preventing the electrolyte solution 42 flowing into the oxygen subsegment 125 from flowing to the combustion chamber(s) 24.

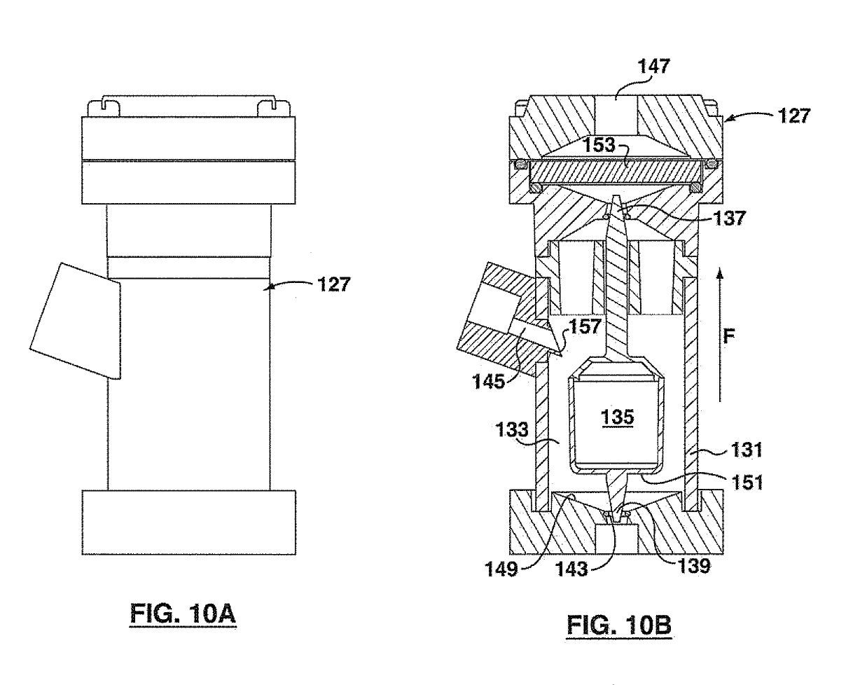

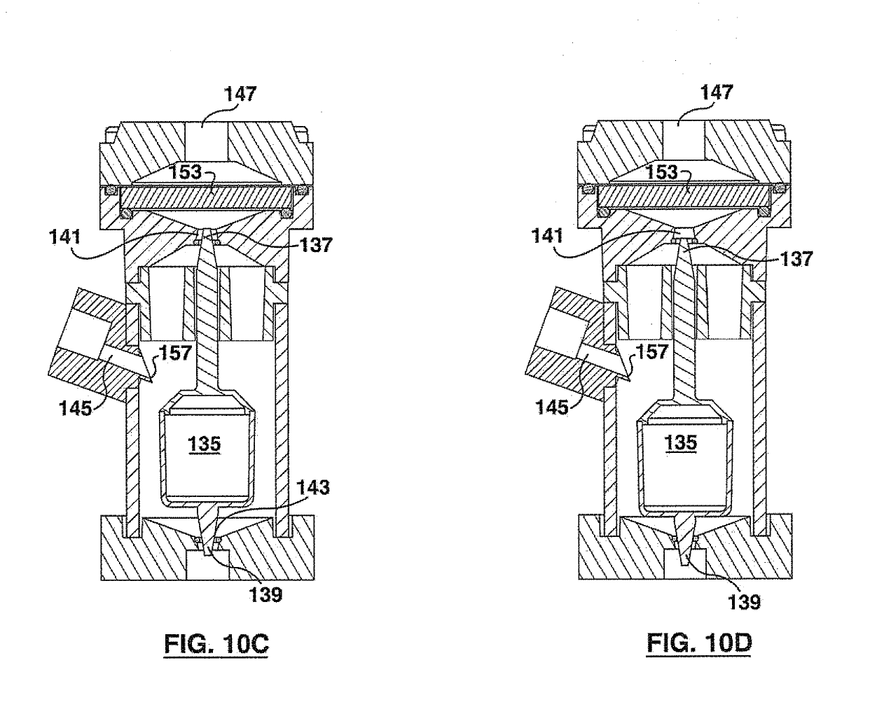

The hydrogen subsegment backflow preventer 127 is illustrated in FIGS. 10A-10D. (It will be understood that only the hydrogen backflow preventer 127 is illustrated in detail for clarity, as the oxygen backflow preventer 129 and the hydrogen backflow preventer unit 127 are substantially the same in all relevant aspects.) As can be seen in FIGS. 10B-10D, the backflow preventer 127 includes a body 131 defining a main chamber 133 therein, in which a float element 135 is mounted. The float element 135 includes upper and lower tips 137, 139, which are both tapered, so that they can be received in upper and lower apertures 141, 143.

As will be described, the float element 135 is movable between a lower closed position (FIG. 10D), in which the lower tip 139 plugs the lower aperture 143, and an upper closed position (FIG. 10B), in which the upper tip 137 plugs the upper aperture 141.

An input tube 145 is provided on a side of the body 131 to direct hydrogen 46 and electrolyte solution 42 into the main chamber 133. When the upper aperture 141 is open, hydrogen 46 from the hydrogen separator chamber 112 entering the main chamber 133 via the input tube 145 moves upwardly, and ultimately through the upper aperture 141, to the hydrogen subsegment 121.

Preferably, the input tube is positioned at a relatively steep angle and has a relatively sharp end 157 to help break drops of liquid from the end of the tube 145, in order to cause liquid in the tube 145 to drain substantially completely. The tube 145 is designed and positioned in this way so that, if the backflow preventer is frozen, the tube 145 is unlikely to be damaged due to liquid inside it.

If the fluid from the oxygen separator chamber 110 entering the main chamber 133 via the input tube 145 includes liquid (i.e., electrolyte solution 42), then the liquid falls to the bottom of the main chamber 133, under the influence of gravity. As can be seen in FIG. 10B, if sufficient electrolyte solution 42 accumulates at the bottom of the main chamber 133, then the float element 135 moves upwardly (i.e., in the direction indicated by arrow F in FIG. 10B), until the upper tip 137 is located in the upper aperture 141. When this happens, if the upper tip 137 is pushed into the upper aperture 141 sufficiently far to seal it, then neither the hydrogen 46 nor the electrolyte solution 42 entering the main chamber 133 can pass through the upper aperture 141. It can therefore be seen that, if sufficient electrolyte solution enters into the main chamber 133, the backflow preventer 127 prevents that liquid from flowing to the combustion chamber(s) 24. As will be described, this is a significant safety feature, for protecting the engine in the event of system failure which may result in overflow of electrolyte solution in the oxygen separator chamber (and/or in the hydrogen separator chamber).

It will be understood that another liquid which is collected in the backflow preventers 127, 129 is condensate.

As can be seen in FIG. 10D, the backflow preventer 127 includes a hole 147 at its upper end, in which a fitting (not shown in FIGS. 10A-10D) is positioned. When the aperture 141 is not blocked, hydrogen moving upwardly through the upper aperture 141 passes through the hole 147 and to the hydrogen subsegment 121.

Preferably, a bottom surface 149 in the backflow preventer 127 is shaped to collect and direct liquid thereon to the lower aperture 143. The float element 135 includes a lower surface 151 that does not nest or seat on the bottom surface 149, to minimize the possibility of damage to the float element 135 in the event that liquid accumulates in the main chamber 133, and the liquid freezes. The backflow preventer 127 preferably also includes a filter element 153, to filter hydrogen gas 46 before it exits the backflow preventer 127 to pass into the hydrogen subsegment 121.

In one embodiment, the oxygen subsegment 125 includes one or more oxygen control valves 159 for controlling the flow of the oxygen 44 to the combustion chamber(s) 24. The oxygen control valve 159 is optional. It will be appreciated by those skilled in the art that, in view of the relatively large amounts of oxygen 44 required to provide the second predetermined volume, and also in view of the relatively unfavourable elemental ratio at which hydrogen and oxygen are produced in the electrolysis assembly 34, in most cases, to provide the second predetermined volume of oxygen 44, no decrease in flow rate is needed, i.e., the valve 159 is not needed.

Referring to FIGS. 2A-2C, the fluid control assembly 108 preferably also includes a connector conduit 161 through which selected ones of the first and second electrolyte solution return pipes 114A, 114B, 116A, 116B are in fluid communication with each other, for facilitating flow of the electrolyte solution 42 through the oxygen conduit 76, the hydrogen conduit 78, the first electrolyte solution conduit 80, and the second electrolyte solution conduit 82. It is also preferred that the fluid control assembly 108 additionally includes a first connector 163 through which the connector conduit 161 and the hydrogen separator chamber 112 are in fluid communication, as will be described.

Those skilled in the art will appreciate that a number of flexible tubes in the fluid control assembly 108 have been omitted from the drawings for clarity. Accordingly, it will be understood that a tube (not shown) connects the top of the first vertical connector 163 and the fitting 167 (FIG. 3F) on the top of the hydrogen separator chamber 112. It has been found that the connector conduit 161, with the first vertical connector 163 in fluid communication therewith and in fluid communication with the hydrogen separator chamber 112, tends to cause the electrolyte solution levels in both of the oxygen and hydrogen separator chambers 110, 112 to be at substantially the same level. This in turn tends to result in substantially steady operation of the electrolytic assembly 34.

Preferably, and as can be seen in FIG. 2A, the first connector 163 is positioned substantially vertical, and includes a portion thereof through which the electrolyte solution therein is viewable. The first connector thus also provides an operator (not shown) with a convenient visual means for checking the level of the electrolyte solution in the system. This is helpful, for example, when the operator first fills the electrolytic assembly, and during maintenance of the system.

In one embodiment, the fluid control assembly 108 preferably includes a second connector 165 in fluid communication with the connector conduit 161, for permitting water to be added to the electrolyte solution 42, until the electrolyte solution substantially includes the predetermined proportions of the electrolyte and water.

As can be seen in FIG. 4, the oxygen exiting the oxygen separator chamber 110 (arrow D1) is directed to the oxygen backflow preventer 129. In normal operation (i.e., in the absence of an excess of electrolyte solution), the oxygen exits the backflow preventer 129 via an upper fitting UF₃ and is directed to the combustion chamber(s) 24 (arrow G_{O}). Liquid exits the backflow preventer 129 via lower fitting LF₁ and is directed away from the combustion chamber(2), for disposal (arrow L_{O}). It will be appreciated that, in normal operation, the liquid thus disposed of is water, i.e., condensate.

Similarly, the hydrogen exiting the hydrogen separator chamber 112 (arrow D2) is directed to the hydrogen backflow separator 127. In normal operation, the hydrogen exits the backflow preventer 127 via an upper fitting UF₂. As can be seen in FIG. 4, the upper fitting UF₂ preferably directs a portion of the hydrogen to the control valve 123, and permits another portion of the hydrogen gas to the vent 189 (arrow G_{H2}). The hydrogen that passes through the control valve 123 is directed to the combustion chamber(s) 24 (arrow G_{H1}). Liquid exits the backflow preventer 127 via lower fitting LF₂, and is directed away from the combustion chamber(s) 24, for disposal (arrow L_{H}). It will be appreciated that, in normal operation, the liquid thus disposed of is water, i.e., condensate.

It will be appreciated by those skilled in the art that the vent 189 is not required in the embodiment of the system in which O₂ and H₂ are provided to the combustion chamber(s) in substantially the elemental ratio.

The system 20 preferably also includes a control assembly 169, having an electronic control module 171 and one or more electrolyte solution level sensors 173. Preferably, the electrolyte solution level sensor(s) 173 are located in the oxygen separator chamber 110 and/or the hydrogen separator chamber 112. The electrolyte solution level sensor 173 is for determining whether a top surface 175 (FIGS. 2B, 2C) of the electrolyte solution 42 in the oxygen separator chamber 110 and/or the hydrogen separator chamber 112 is within a predetermined range defined by a predetermined upper level and a predetermined lower level. The electrolyte solution level sensor 173 is adapted to provide one or more signals to the electronic control module 171 when the electrolyte solution level 175 is outside the predetermined range.

In one embodiment, each sensor preferably is a capacitance sensor, e.g., a metal screw, the capacitance of which is measured by the electronic control module 171 at predetermined intervals. For instance, as indicated in FIG. 2A, upper and lower sensors 173A, 173B are located in the wall of the oxygen separator chamber 110, and upper and lower sensors 173C, 173D are located in the wall of the hydrogen separator chamber 112. It is preferred that the upper sensors 173A, 173C are at substantially the same height, and the lower sensors 173B, 173D are also at substantially the same height. (The electrolytic assembly and the fluid control assembly preferably are positioned substantially horizontal when in operation.)

It is also preferred that the electronic control module 171 is adapted to provide a signal requiring water to be added to the electrolyte solution 42, upon receipt of a first signal from the electrolyte solution level sensor 173 indicating that the top surface 175 of the electrolyte solution is below the predetermined lower level.

As can be seen, for example, in FIG. 2A, the sensors 173A, 173C are located at the predetermined upper level, and the sensors 173B, 173D are located at the predetermined lower level. In this example, the top surface identified in FIG. 2A as 175A is within the predetermined range. However, if the top surface drops to the position at which it is identified as 175B, then water is required to be added to the electrolyte solution, in order that the solution has the necessary volume.

When both of the lower sensors 173B, 173D indicate that they are not engaged by the electrolyte solution, the electronic control module 171 determines that water is required to be added, and provides a signal accordingly.

It will be appreciated by those skilled in the art that, when more water is needed, water may be added to the electrolyte solution manually, upon the appropriate signal being provided. For instance, an audible or visual signal could be provided to the operator, to indicate to the operator that water is required to be added.

However, it is preferred that the system provides for water to be added to the electrolyte solution automatically, when necessary. In one embodiment, the fluid control assembly additionally includes a water container 181, for holding water, and a tube 183 connecting the water container 181 to the second connector 165, to permit water to flow from the water container 181 into the second connector 165 for addition thereof to the electrolyte solution.

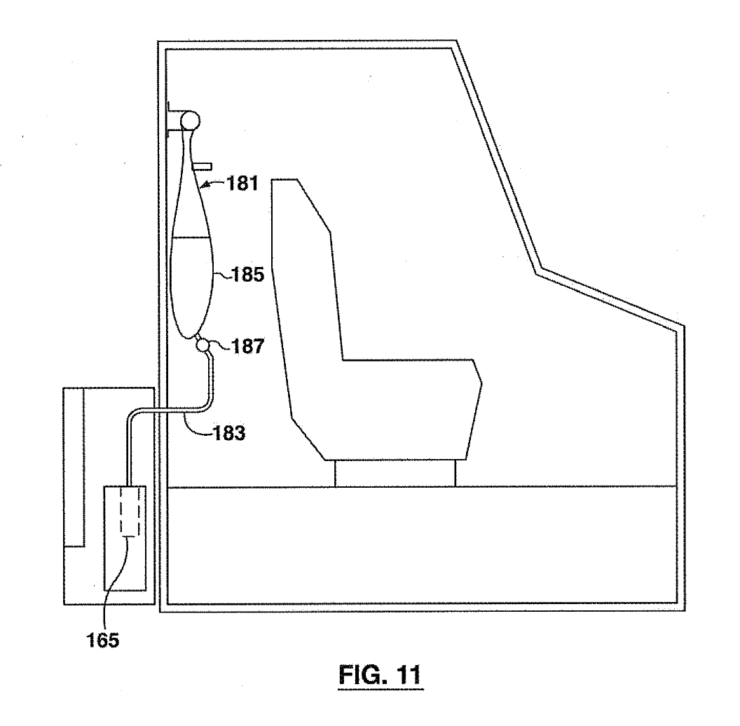

It will be understood that, if the water container 181 is mounted in a vehicle (FIG. 11), then the container 181 preferably is manually replenished from time to time by the operator. As illustrated in FIG. 11, it is preferred that the container 181 is located in the cab of the vehicle. This is preferred because, if the water in the container freezes, the water will thaw relatively rapidly, due to heated air circulating in the cab, for the operator's comfort.

Preferably, the water container 181 has one or more flexible walls 185, so that upon the water in the container 181 freezing, the container 181 is substantially undamaged. In addition, the water container 181 is preferably positioned above the second connector 165, so that the water flows from the water container 181 to the second connector 165 under the influence of gravity.

In one embodiment, the control assembly 169 additionally includes a water reservoir solenoid valve 187 controlled by the electronic control module 171 so that, upon the signal to add water being provided, the water reservoir solenoid valve 187 is opened, to permit the water to flow into the second connector 165.

In one embodiment, the electronic control module 171 preferably determine that both sensors 173B, 173D agree (i.e., they both indicate that the top surface 175 is below them respectively) before the electronic control module 171 causes the water reservoir solenoid valve 187 to open.

Preferably, after the signal to add water has been transmitted, in the event that the electrolyte solution level 175 has not risen to the upper sensors 173A, 173C within a predetermined time period (e.g., 30 minutes), the electronic control module 171 disconnects the main power source, thereby shutting down the system.

This situation is also illustrated in FIG. 2A, in which the top surface of the electrolyte solution which is above the predetermined upper level is identified as 175C.

As can be seen in FIG. 12, it is preferred that the electronic control module 171 is powered by a power source PS separate from the power source 32. For instance, the power source PS may be 12 volt direct current power, from the truck cab control power. Preferably, the electronic control module 171 is a suitable computing device, e.g., which may include firmware, as is known in the art. Also, the control assembly 169 preferably includes a main power switch 195.

When the control assembly 169 is activated (e.g., by moving the switch 195 to the appropriate position), the electronic control module 171 is activated. The electronic control module checks various parameters of the system (e.g., electrolyte solution level in the oxygen and hydrogen separator chambers 110, 112) to ensure that the system is ready for operation. If it is, then a main solenoid 197 is activated, which allows the power source 32 to energize the electrodes E in the electrolytic assembly 34 to which the power source 32 is electrically connected. Preferably, the power source 32 is 12 volt direct current, provided by the battery or from the alternator/generator of the engine, as the case may be.

In one embodiment, the hydrogen subsegment 121 also includes one or more hydrogen release vents 189 (FIG. 4) for directing a preselected amount of the hydrogen 46 away from the combustion chamber(s) 24 so that the first predetermined volume of hydrogen 46 is directed to the combustion chamber(s) 24.

As described above, in one embodiment, the system provides O₂ and H₂ to the combustion chamber(s) 24 in substantially the elemental ratio. However, in another embodiment, and as described above, the system provides O₂ and H₂ in a non-elemental ratio. For example, in one embodiment, O₂ and H₂ are provided in the non-elemental ratio of approximately 3:1. In that embodiment, it is necessary that the H₂ produced be directed away from the engine, due to the use of the non-elemental ratio of oxygen to hydrogen in the system herein. That is, because the electrolytic assembly produces O₂ and H₂ at the elemental ratio of approximately 1:2, but (according to one embodiment of the invention herein) the O₂ and H₂ preferably are provided to the combustion chamber(s) 24 at the non-elemental ratio of approximately 3:1, the system 20 preferably includes a means for disposing of the excess hydrogen, i.e., via the vent 189. From the foregoing, it will be appreciated by those skilled in the art that the vent 189 is optional.

As will be described, in order to determine the first and second predetermined volumes for a particular type of engine (e.g., Detroit Diesel 60) to a high degree of accuracy, testing is done. This provides the first and second predetermined volumes (e.g., in terms of flow rate, in litres per minute) which are generally optimum for the model of diesel engine tested, the predetermined volumes determining a preselected non-elemental ratio.

However, those skilled in the art will appreciate that there are differences between individual diesel engines (i.e., resulting in minor variations in the optimum first and second predetermined volumes determined for a particular model of engine). In addition, the performance of a specific engine with particular first and second predetermined volumes may vary over time, e.g., if the vehicle is driven consistently in varying terrains, or by different drivers, so that even for that specific engine, the optimum first and second predetermined volumes may vary slightly over time. Accordingly, it is preferred to permit some adjustment of the first and second predetermined volumes from those determined for an engine model.

Those skilled in the art will appreciate that the hydrogen control valve 123 could be manually adjusted, to take differences over time for the specific engine into account, so as to provide the optimum first and second predetermined volumes. In the alternative, however, the hydrogen control valve 123 may be automatically adjusted.

For instance, in one embodiment, the control assembly 169 preferably includes means 191 for providing current data about the engine's performance to the electronic control module 171 (FIG. 12), almost on a real-time basis, or otherwise, as required. It is preferred that the means 191 is a “truck computer”, in which the relevant data (e.g., mileage (mpg) for a particular time period) is readily available. The electronic control module 171 preferably is adapted to compare the current data to preselected performance parameters, and to determine one or more adjustments to a servo needle valve 123′, for improving performance of the engine relative to the real-time data. Preferably, the electronic control module 171 is also operably connected to the control valve 123′, for adjusting the hydrogen control valve 123′.

As can be seen in FIG. 3F, the electrolytic assembly 34 preferably includes a bilge element 199, for collecting electrolyte solution that leaks from the electrolytic cells. The electrolytic solution is corrosive, and so the collection of any leaked electrolyte solution is needed, for safety. Accordingly, the bilge element 199 is substantially watertight. The control assembly 169 preferably includes a bilge sensor 201 for sensing the electrolyte solution (if any) collected in the bilge element 199. If electrolyte solution is detected by the bilge sensor 201, then the electronic control module 171 causes the electrolytic assembly 34 to cease operating.

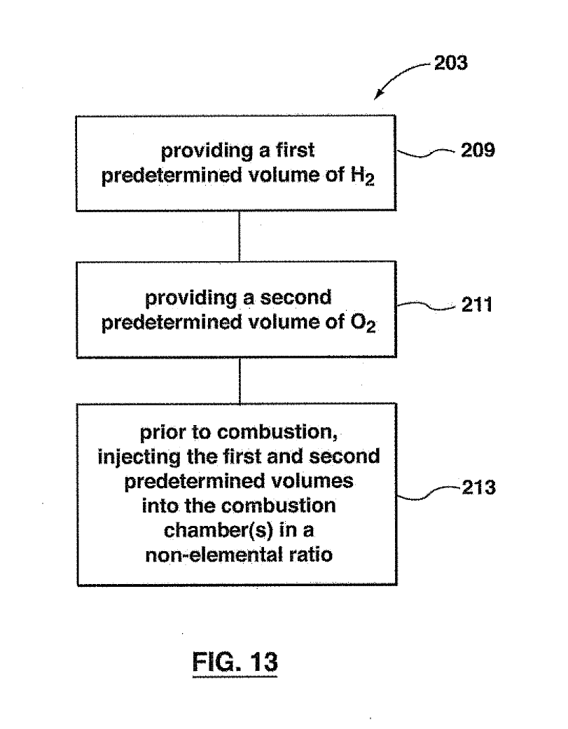

As can be seen in FIG. 13, in another embodiment, an embodiment of a method 203 of the invention includes, first, providing a first volume of substantially pure oxygen gas (step 209, FIG. 13), and providing a second volume of substantially pure hydrogen gas (step 211). (It will be understood that these steps may be performed in any order suitable, or simultaneously.) Also, the method 203 includes, prior to combustion, injecting the first volume and the second volume into the combustion chamber(s) in a non-elemental ratio (step 213).

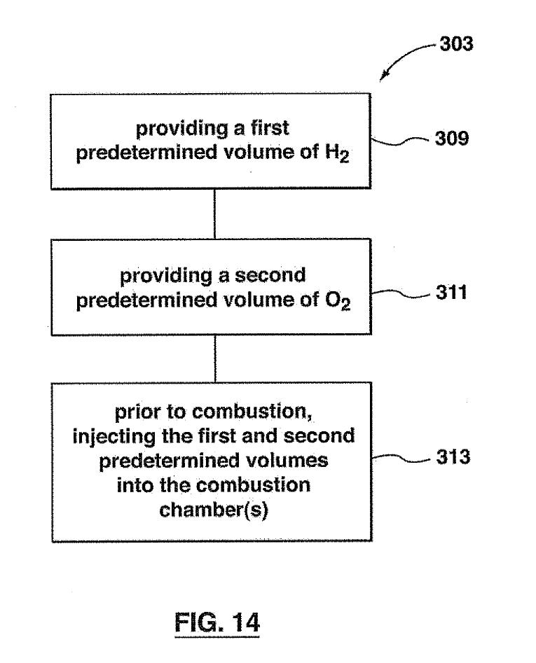

As can be seen in FIG. 14, another embodiment of a method 303 of the invention includes providing a first volume of substantially pure oxygen gas (step 309, FIG. 14), and providing a second volume of substantially pure hydrogen gas (step 311). Also, the method, 30 includes, prior to combustion, injecting the first volume and the second volume into the combustion chamber in an elemental ratio (step 313).

It will be understood that the elements herein may be made of any suitable materials. However, it is preferred that the spacer bodies and grill elements are made out of PVC plastic (polyvinyl chloride). Preferably, the electrodes are made of stainless steel, treated as described above. The return pipes and separator chambers preferably are also made of PVC plastic. The gaskets preferably are made of neoprene rubber, and the diaphragm element preferably is made of nylon, as described above.

The system has been designed for retrofitting and to take into account the possibility that the system may be allowed to freeze. The electrolyte solution does not freeze above approximately −40° C. As described above, the water container 181 is designed to accommodate the water therein freezing. Electrical power is provided by the electrical system which is included with the existing diesel engine. The electrolytic assembly preferably is mounted to the vehicle using known techniques and devices, as can be seen, e.g., in FIG. 3F. It is preferred that the electrolytic assembly is protected by a cover (not shown) while operating.

### INDUSTRIAL APPLICABILITY

In use, the electrolytic assembly is first filled with the electrolyte solution, via the second connector. Water is added to the water container, in the operator's cab. As described above, the unit is activated upon the operator causing a switch to close a circuit, resulting in electrical energy being provided to selected electrodes E in the electrolytic assembly.

As described above, once electrolysis has begun, the hydrogen and oxygen produced in the electrolytic cells exit therefrom, pushing the electrolyte solution to the hydrogen and oxygen separator chambers respectively, where the hydrogen and oxygen are separated respectively from the electrolyte solution. Accordingly, once in operation, the electrolyte solution is circulated through the electrolytic assembly, and no pump is required.

As described above, the hydrogen and oxygen exit from the upper ends of the hydrogen and oxygen separator chambers. Preferably, the hydrogen is controlled by a hydrogen control valve, and excess hydrogen is released to the atmosphere or elsewhere by the hydrogen release vent, so that the first predetermined volume of hydrogen is provided to the combustion chamber(s). The oxygen is also provided to the combustion chamber(s), in the second predetermined volume.

As described above, the system provides oxygen and hydrogen to the combustion chamber(s) 24 in a preselected non-elemental ratio. For example, for a typical diesel truck engine, the system directs approximately 2 litres per minute of oxygen, and approximately 700 ml per minute of hydrogen.

It will be appreciated by those skilled in the art that the invention can take many forms, and that such forms are within the scope of the invention as described above. The foregoing descriptions are exemplary and their scope should not be limited to the preferred versions contained herein.

1-35. (canceled)

36. A system for controlling combustion in a diesel engine having at least one combustion chamber in which diesel fuel is injected and air is compressed for combustion of the fuel, the system comprising:
a hydrogen injector configured to inject a first predetermined volume of hydrogen into said at least one combustion chamber prior to combustion of the diesel fuel; and
an oxygen injector configured to inject a second predetermined volume of oxygen into said at least one combustion chamber prior to combustion of the diesel fuel, the second predetermined volume and the first predetermined volume defining a non-elemental ratio of the second predetermined volume to the first predetermined volume.

37. The system according to claim 36, wherein the non-elemental ratio is between approximately 3:1 and approximately 3:1.5.

38. The system according to claim 36, further comprising:
a source of electrical power; and
at least one electrolytic assembly electrically connectable to the source of electrical power to generate the first and second predetermined volumes of hydrogen and oxygen respectively.

39. The system according to claim 38, wherein said at least one electrolytic assembly comprises:
at least one cathode;
at least one anode;
said at least one cathode and said at least one anode at least partially defining an electrolytic cell therebetween; and
an electrolyte solution comprising water and an electrolyte, said electrolyte solution being positionable in the electrolytic cell, wherein the electrolyte solution is configured to be subjected to electrolysis when the source of electrical power is electrically connected to said at least one anode to cause the water to at least partially decompose into oxygen and hydrogen.

40. The system according to claim 39, wherein said at least one electrolytic assembly comprises a diaphragm element positioned between said at least one cathode and said at least one anode for dividing the electrolytic cell into an oxygen compartment and a hydrogen compartment.

41. The system according to claim 40, wherein the diaphragm element is positioned substantially equidistant from said at least one cathode and said at least one anode.

42. The system according to claim 41, wherein said at least one cathode and said at least one anode are spaced apart by a distance of approximately 19 mm.

43. The system according to claim 42, wherein said at least one electrolytic assembly includes at least one spacer body arranged to locate the diaphragm element.

44. The system according to claim 43, wherein said at least one electrolytic assembly further comprises a plurality of gaskets, each said gasket being positioned between said at least one spacer body and a selected one of said at least one cathode and said at least one anode respectively, to provide substantially watertight seals between said at least one cathode and said at least one anode respectively and said at least one spacer body.

45. The system according to claim 44, wherein at least a selected one of said at least one cathode and said at least one anode comprises a fin portion thereof configured to extend outwardly from the gasket to dissipate heat generated by electrolysis in the electrolytic cell.

46. The system according to claim 38, wherein said at least one electrolytic assembly comprises:
a plurality of cathodes and a plurality of anodes, said cathodes and said anodes being arranged in pairs, each said pair of said cathode and said anode at least partially defining an electrolytic cell therebetween;
each said electrolytic cell at least partially being defined by a spacer subassembly, each said spacer subassembly comprising:
a spacer body;
a diaphragm element;
a grill element positioned to hold the diaphragm element against the spacer body, the grill element being secured to the spacer body;
the diaphragm element being located by the spacer body in a predetermined location approximately midway between the cathode and the anode for the electrolytic cell to partially define:
an oxygen compartment in which the electrolyte solution is engaged with the anode for the electrolytic cell, and in which oxygen appears when the electrolyte solution is subjected to electrolysis; and
a hydrogen compartment in which the electrolyte solution is engaged with the cathode for the electrolytic cell, and in which hydrogen appears when the electrolyte solution is subjected to electrolysis.

47. The system according to claim 46, wherein
said at least one electrolytic assembly additionally comprises a plurality of gaskets; and
for each said electrolytic cell, two of said gaskets are mounted between the cathode and the anode respectively, between which the spacer body is positioned.

48. The system according to claim 47, wherein
each said spacer body comprises an oxygen conduit portion, a hydrogen conduit portion, a first electrolyte solution conduit portion, and a second electrolyte solution conduit portion;
said spacer bodies configured to define:
an oxygen conduit comprising said oxygen conduit portions configured to permit oxygen and electrolyte solution to flow from the oxygen compartments;
a hydrogen conduit comprising said hydrogen conduit portions configured to permit hydrogen and electrolyte solution to flow from the hydrogen compartments;
a first electrolyte solution conduit comprising said first electrolyte conduit solution portions configured to permit the electrolyte solution to flow into the oxygen compartments;
a second electrolyte solution conduit comprising said second electrolyte conduit solution portions configured to permit the electrolyte solution to flow into the hydrogen compartments;
wherein each said spacer body further comprises:
an oxygen output tube in fluid communication with the oxygen compartment and the oxygen conduit portion configured to permit the oxygen and the electrolyte solution to flow from the oxygen compartment into the oxygen conduit;
a hydrogen output tube in fluid communication with the hydrogen compartment and the hydrogen conduit portion configured to permit the hydrogen and the electrolyte solution to flow from the hydrogen compartment into the hydrogen conduit;
a first electrolyte solution input tube in fluid communication with the oxygen compartment and the first electrolyte solution conduit portion configured to permit the electrolyte solution to flow from the first electrolyte solution conduit into the oxygen compartment; and
a second electrolyte solution input tube in fluid communication with the hydrogen compartment and the second electrolyte solution conduit portion configured to permit the electrolyte solution to flow from the second electrolyte solution conduit into the hydrogen compartment.

49. The system according to claim 46, wherein each of said cathodes and each of said anodes comprises:
an engagement region positioned for engagement with the electrolyte solution in the electrolytic cell at least partially defined by said cathode and said anode; and
the engagement region being treated to substantially remove discontinuities thereon.

50. The system according to claim 48, further comprising a fluid control assembly to control flows of fluids to and from the electrolytic assembly.

51. The system according to claim 48, wherein the fluid control assembly comprises:
an oxygen separator chamber, in which the oxygen and the electrolyte solution provided from the oxygen compartments via the oxygen conduit are collected, and separated by gravity;
a hydrogen separator chamber, in which the hydrogen and the electrolyte solution provided from the hydrogen compartments via the hydrogen conduit are collected, and separated by gravity;
a pair of first electrolyte solution return pipes, one of each said first electrolyte solution return pipes configured to extend from each of the oxygen separator chamber and the hydrogen separator chamber respectively to the first electrolyte solution conduit, for directing the electrolyte solution from the oxygen separator chamber and the hydrogen separator chamber respectively to the first electrolyte solution conduit; and
a pair of second electrolyte solution return pipes, one of each said second electrolyte solution return pipes configured to extend from each of the oxygen separator chamber and the hydrogen separator chamber respectively to the second electrolyte solution conduit, for directing the electrolyte solution from the oxygen separator chamber and the hydrogen separator chamber respectively to the second electrolyte solution conduit.

52. The system according to claim 51, wherein the fluid control subassembly comprises a gas direction segment configured to direct the first predetermined volume of hydrogen and the second predetermined volume of oxygen from the hydrogen separator chamber and the oxygen separator chamber respectively to said at least one combustion chamber.

53. The system according to claim 52, wherein the gas direction segment comprises:
a hydrogen subsegment configured to permit the hydrogen to flow from the hydrogen separator chamber to said at least one combustion chamber, the hydrogen subsegment comprising at least one hydrogen control valve for controlling the flow of said hydrogen to said at least one combustion chamber; and
an oxygen subsegment configured to permit the oxygen to flow from the oxygen separator chamber to said at least one combustion chamber.

54. The system according to claim 53, wherein the hydrogen subsegment comprises a hydrogen subsegment backflow preventer configured to prevent the electrolyte solution flowing into the hydrogen subsegment from flowing to said at least one combustion chamber.

55. The system according to claim 53, wherein the oxygen subsegment comprises an oxygen subsegment backflow preventer configured to prevent the electrolyte solution flowing into the oxygen subsegment from flowing to said at least one combustion chamber.

56. The system according to claim 53, wherein the oxygen subsegment comprises at least one oxygen control valve configured to control the flow of said oxygen to said at least one combustion chamber.

57. The system according to claim 51, wherein the fluid control assembly additionally comprises:
a connector conduit through which selected ones of the first and second electrolyte solution return pipes are in fluid communication with each other, for facilitating flow of electrolyte solution through the oxygen conduit, the hydrogen conduit, the first electrolyte solution conduit, and the second electrolyte solution conduit; and
a first connector, through which the connector conduit and the hydrogen separator chamber are in fluid communication.

58. The system according to claim 57, wherein the fluid control assembly further comprises:
a second connector, in fluid communication with the connector conduit configured to permit water to be added to the electrolyte solution, until the electrolyte solution substantially comprises predetermined proportions of the electrolyte and water.

59. The system according to claim 58, wherein the fluid control assembly further comprising a control assembly, said control assembly comprising:
an electronic control module; and
at least one electrolyte solution level sensor located in a separator chamber selected from the group consisting of the oxygen separator chamber and the hydrogen separator chamber to determine whether a top surface of the electrolyte solution therein is within a predetermined range defined by a predetermined upper level and a predetermined lower level, said at least one electrolyte solution level sensor being arranged to provide at least one signal to the electronic control module when the top surface of the electrolyte solution is outside the predetermined range.

60. The system according to claim 59, wherein
the electronic control module is arranged to provide said at least one signal requiring water to be added to the electrolyte solution, upon receipt of a first signal from said at least one electrolyte solution level sensor configured to indicate that the top surface of the electrolyte solution is below the predetermined lower level.

61. The system according to claim 60, wherein the fluid control assembly further comprises:
a water container configured to hold water; and
a tube connecting the water container to the second connector to permit water to flow from the water container into the second connector for addition thereof to the electrolyte solution.

62. The system according to claim 61, wherein the container comprises at least one flexible wall, such that upon the water in the container freezing, the container is not damaged.

63. The system according to claim 61, wherein the water container is positioned above the second connector, such that the water flows from the water container to the second connector under the influence of gravity.

64. The system according to claim 63, wherein the control assembly additionally comprises a water reservoir solenoid valve controlled by the electronic control module such that, upon the electronic control module providing said at least one signal, the water reservoir solenoid valve is opened, to permit the water in the container to flow into the second connector.

65. The system according to claim 53, wherein the hydrogen subsegment additionally comprises at least one hydrogen release valve for directing a preselected amount of the hydrogen away from said at least one combustion chamber such that the first predetermined volume of hydrogen is directed to said at least one combustion chamber.

66. The system according to claim 53, further comprising a control assembly, the control assembly comprising:
an electronic control module;
a device for providing real-time data about the engine's performance to the electronic control module;
the electronic control module being configured to compare the real-time data to preselected performance parameters, and to determine at least one adjustment to said at least one hydrogen control valve to improve performance of the engine relative to the real-time data; and
an adjustment unit to make said at least one adjustment to said at least one hydrogen control valve.

67. A method of controlling combustion in a diesel engine including at least one combustion chamber in which diesel fuel injected into a compressed volume of air combusts, the method comprising:
providing a first volume of substantially pure oxygen gas;
providing a second volume of substantially pure hydrogen gas; and
prior to combustion of the diesel fuel, injecting the first volume and the second volume into said at least one combustion chamber in a non-elemental ratio.

68. A method of controlling combustion in a diesel engine including at least one combustion chamber in which diesel fuel injected into a compressed volume of air combusts, the method comprising:
providing a first volume of substantially pure oxygen gas;
providing a second volume of substantially pure hydrogen gas; and
prior to combustion of the diesel fuel, injecting the first volume and the second volume into said at least one combustion chamber in an elemental ratio.

69. A system for controlling combustion in a diesel engine having at least one combustion chamber in which diesel fuel is injected and air is compressed for combustion of the fuel, the system comprising:
a hydrogen injector configured to inject a first predetermined volume of hydrogen into said at least one combustion chamber prior to combustion of the diesel fuel; and
an oxygen injector configured to inject a second predetermined volume of oxygen into said at least one combustion chamber prior to combustion of the diesel fuel.

70. The system according to claim 69, wherein the second predetermined volume and the first predetermined volume define an elemental ratio of the second predetermined volume to the first predetermined volume.
